(19) United States
(12) Patent Application Publication
(10) Pub. No.: US 2020/0387557 A1
(43) Pub. Date: Dec. 10, 2020

(54) SYSTEM, PROGRAM, AND RECORDING MEDIUM FOR DISPLAYING WEB PAGES

(71) Applicant: SYMMETRIC CO., LTD., Tokyo (JP)

(72) Inventors: Kazutoshi SAKATA, Tokyo (JP); Jun NAKANISHI, Tokyo (JP)

(73) Assignee: SYMMETRIC CO., LTD., Tokyo (JP)

(21) Appl. No.: 16/326,492

(22) PCT Filed: Aug. 26, 2016
(86) PCT No.: PCT/JP2016/074989

§ 371 Date: Jun. 13, 2019

(51) Int. Cl. G06F 16/958; G06F 16/955; G06F 16/957

(52) U.S. Cl. CPC G06F 16/958; G06F 16/957; G06F 16/955

(57) ABSTRACT

Rendering engine of web page display system generates a web page using data received from Web server device group. Associating unit of web page display system extracts data and URIs of link destinations from layout data generated by rendering engine in generating a web page, and stores them in association with drawing data indicating a displayed image. The extracted data indicates displayed areas of link elements, which are elements linked to another web page among elements of the web page. Display control unit controls display to display a displayed image of a web page by using the drawing data. When a user performs mouseover on any of the link elements of the web page, display control unit controls display to display a web page linked to the link element by using the drawing data.

### TECHNICAL FIELD

The present invention relates to a technique for displaying web pages.

### BACKGROUND ART

Techniques have been proposed in which captured images of web pages and menu screens are acquired and displayed as substitutes for acquired web pages and menu screens. For example, in JP2008-9892A, an invention is described in which, when a client terminal displays a first web page including a hyperlink to a second web page, the client terminal acquires a captured image of the second web page and displays the captured image. In JP2015-114934A, an invention is described in which an image forming apparatus stores a captured image of a menu screen when the menu screen is displayed for the first time on a touch screen, based on a menu script. When displaying the menu screen again, the image forming apparatus displays the captured image first. When a new menu script is generated, the image forming apparatus displays a new image based on the new menu script, instead of the captured image.

### SUMMARY OF INVENTION

There is known an information providing service for analysing access to Web sites. The information providing service provides a user with a variety of statistical information such as a number of views and a number of conversions for each of a plurality of web pages included in registered Web sites.

An administrator of a web site considers measures for improving the web site while referring to the statistical information provided by the information providing service. Thus, the administrator is required to check relations between linked web pages, in addition to contents of individual web pages. Consequently, the administrator is required to repeatedly open and close a large number of mesh-pattern-linked web pages.

In view of the above-stated background, an object of the present invention is to provide means for enabling a user such as an administrator of a web site to promptly gain an overview of contents of the web site.

To solve the above-stated problem, in a first embodiment the present invention provides a system comprising an acquisition unit that acquires drawing data and layout data for each of a plurality of web pages, the drawing data indicating a displayed image of a web page and generated by a rendering engine in accordance with data described in a web page description language, the layout data indicating a displayed area and an attribute of each of a plurality of elements included in the web page, the displayed area being decided by the rendering engine in generating the displayed image of the web page; an associating unit that extracts one or more displayed areas from a plurality of displayed areas indicated by the layout data of each of the plurality of web pages, the extracted one or more displayed areas having a link as the attribute, and associates link data to the drawing data of the web page with respect to each of the extracted one or more displayed areas, the link data indicating the displayed area and a destination added to the displayed area; and a display control unit that controls a display to display an image of a web page, which is selected by a user from among the plurality of the web pages, wherein if a predetermined operation is performed by the user on any one of the one or more displayed areas to which the link data is associated, while a first web page is displayed on the display under the control of the display control unit in accordance with first drawing data, the display control unit controls the display to display a second web page indicated by second drawing data acquired by the acquisition unit, so as to display an image of a web page of a link destination corresponding to the link data.

As a second mode, a configuration may be adopted in which, in the system according to the first mode, the acquisition unit acquires group data indicating to which group each of the plurality of web pages belongs; the display control unit controls the display to display a menu image that includes a plurality of displayed areas for images of operation elements, each of the displayed areas corresponding to each of groups indicated by the group data, each of the images of operation elements corresponding to each of web pages belonging to the groups, the images of operation elements being arranged in a matrix in the corresponding displayed areas of the groups; and if a predetermined operation is performed by the user on any one of the images of operation elements, while the menu image is displayed by the display according to control of the display control unit, the display control unit controls the display to display a web page indicated by third drawing data acquired by the acquisition unit, so as to display an image of a web page corresponding to the image of the operation element.

As a third mode, a configuration may be adopted in which, in the system according to the second mode, the acquisition unit acquires viewing number data indicating a number of times of viewing by visitors moving from a web page selected by a user to a linked web page during a past predetermined period, for each of one or more web pages accessed via a link from the web page selected during the predetermined period; and the display control unit controls the display to display the images of operation elements in the menu image, each of the images of operation elements including a number of viewing times indicated by the viewing number data and corresponding to each of one or more web pages accessed via a link from the selected web page.

As a fourth mode, a configuration may be adopted in which, in the system according to the second mode, the acquisition unit acquires viewing number data indicating a number of times of viewing by visitors moving from a link source web page to a web page selected by a user during a past predetermined period, for each of one or more web pages linked to the web page selected during the predetermined period; and the display control unit controls the display to display the images of operation elements in the menu image, each of the images of operation elements including a number of viewing times indicated by the viewing number data and corresponding to each of one or more web pages linked to the selected web page.

As a fifth mode, a configuration may be adopted that, in the system according to any of the first to fourth modes, comprises a server device that has the acquisition unit, the associating unit, and a transmission unit that transmits the drawing data and the link data related to each of the plurality of web pages; and a terminal device that has a receiving unit and the display control unit, the receiving unit receiving the drawing data and the link data related to each of the plurality of web pages from the server device.

The present invention provides, as a sixth embodiment, a computer program that causes a computer to execute processes comprising: a process for acquiring drawing data and layout data with respect to each of a plurality of web pages, the drawing data indicating a displayed image of a web page and being generated by a rendering engine in accordance with data described in a web page description language, the layout data indicating a displayed area and an attribute of each of a plurality of elements included in the web page, the displayed area being decided by the rendering engine in generating the displayed image of the web page; a process for extracting one or more displayed areas from a plurality of displayed areas indicated by the layout data of each of the plurality of web pages, the extracted one or more displayed areas having a link as the attribute, and associating link data to the drawing data of the web page with respect to each of the extracted one or more displayed areas, the link data indicating the displayed area and a destination added to the displayed area; a process for controlling a display to display an image of a web page, which is selected by a user from among the plurality of the web pages; a process for controlling, if a predetermined operation is performed by the user on any one of the one or more displayed areas to which the link data is associated while a first web page is displayed on the display under the control in accordance with first drawing data, the display to display a second web page indicated by second drawing data, so as to display an image of a web page of a link destination corresponding to the link data.

The present invention provides, as a seventh embodiment, a computer-readable recording medium storing a computer program that causes a computer to execute processes comprising: a process for acquiring drawing data and layout data with respect to each of a plurality of web pages, the drawing data indicating a displayed image of a web page and being generated by a rendering engine in accordance with data described in a web page description language, the layout data indicating a displayed area and an attribute of each of a plurality of elements included in the web page, the displayed area being decided by the rendering engine in generating the displayed image of the web page; a process for extracting one or more displayed areas from a plurality of displayed areas indicated by the layout data of each of the plurality of web pages, the extracted one or more displayed areas having a link as the attribute, and associating link data to the drawing data of the web page with respect to each of the extracted one or more displayed areas, the link data indicating the displayed area and a destination added to the displayed area; a process for controlling a display to display a displayed image of a web page, which is selected by a user from among the plurality of the web pages; a process for controlling, if a predetermined operation is performed by the user on any one of the one or more displayed areas to which the link data is associated while a first web page is displayed on the display under the control in accordance with first drawing data, the display to display a second web page indicated by second drawing data, so as to display an image of a web page of a link destination corresponding to the link data.

According to embodiments of the present invention, as in a case of a normal browser displaying a web page using data acquired from a Web server, it is possible for a user to display the linked web page by performing a predetermined operation such as clicking on a link element (an element providing a link to another web page) included in the web page currently displayed.

However, in embodiments of the present invention, when a web page is displayed according to the operation of a user, the web page is displayed according to the drawing data of the web page generated in advance by a rendering engine. Therefore, according to the present invention, display of the web page is performed at remarkably high speed, as compared with a case where a normal browser displays the web page. That is, according to the present invention, a user such as an administrator of a Web site can promptly perform an operation of sequentially browsing many web pages links to which are included in the Web site.

Further, in a system according to embodiments of the present invention it is not necessary to perform data communication with a Web server after associating the drawing data with the link data. Therefore, by using the system according to the present invention, after association between the drawing data and the link data is completed, a user can sequentially browse web pages according to the link even in an environment where communication with the Web server is impossible.

### BRIEF DESCRIPTION OF THE DRAWINGS

FIG. 1 illustrates a configuration of a system including a web page display system according to the first embodiment.

FIG. 2 illustrates a configuration of a computer used for implementing the web page display system according to the first embodiment or the terminal device according to the second embodiment or the third embodiment.

FIG. 3 illustrates a functional configuration of the web page display system according to the first embodiment.

FIG. 4 illustrates a configuration of the web page table according to the first embodiment.

FIG. 5 illustrates a web page browsing screen according to the first embodiment.

FIG. 6 illustrates a web page browsing screen according to the first embodiment.

FIG. 7 illustrates a web page browsing screen according to the first embodiment.

FIG. 8 illustrates a web page browsing screen according to the first embodiment.

FIG. 9 illustrates a web page browsing screen according to the first embodiment.

FIG. 10 illustrates a web page browsing screen according to the first embodiment.

FIG. 11 illustrates a configuration of a system including the web page display system according to the second embodiment.

FIG. 12 illustrates a configuration of a computer used for implementing the server device according to the second embodiment or the third embodiment.

FIG. 13 illustrates a configuration of a web page display system according to the second embodiment.

FIG. 14 illustrates a configuration of the system including the web page display system according to the third embodiment.

FIG. 15 illustrates a functional configuration of the web page display system according to the third embodiment.

### DETAILED DESCRIPTION

### 1. Embodiment

Web page display system 11 according to a first embodiment of the present invention will be described below. FIG. 1 illustrates a configuration of system 1 including web page display system 11. System 1 includes web page display system 11, display 12 and input device 13 connected to web page display system 11, Web server device group 14, and access analysis server device 15. Web page display system 11 performs data communication with Web server group 14 and access analysis server device 15 via Internet 9.

Web server device group 14 is a group of known Web server devices that transmits various data required for displaying a web page to a requesting Web browser, in response to a request from the Web browser. It is to be noted that the various data required for displaying a web page includes data described in a web page description language such as HTML (HyperText Markup Language), image data, audio data, and the like. In addition, the data described in a web page description language may include data described in a script language such as JavaScript (registered trademark) and/or a style sheet such as CSS (Cascading Style Sheet).

Access analysis server device 15 is a known access analysis server device that analyzes accesses to a Web site registered by a user and transmits access analysis data showing an analysis result (hereinafter referred to as “access analysis information”) to a terminal device or the like of the user. It is to be noted that the access analysis information indicated by data provided by access analysis server device 15 includes, for example, a number of browsings of an entire Web site within a past predetermined period, a number of browsings of each web page in the Web site, an outflow rate from each web page in the Web site, search keywords used by visitors to visit the Web site, moving route and transition number between web pages of visitors of the Web site, a ratio (a conversion rate) of visitors who performed a predetermined operation on a predetermined web page among visitors of the Web site, and the like.

Web page display system 11 is a system for displaying to a user access analysis information on a web page registered by the user and a web page selected by the user. The user of web page display system 11 is, for example, an administrator of a Web site.

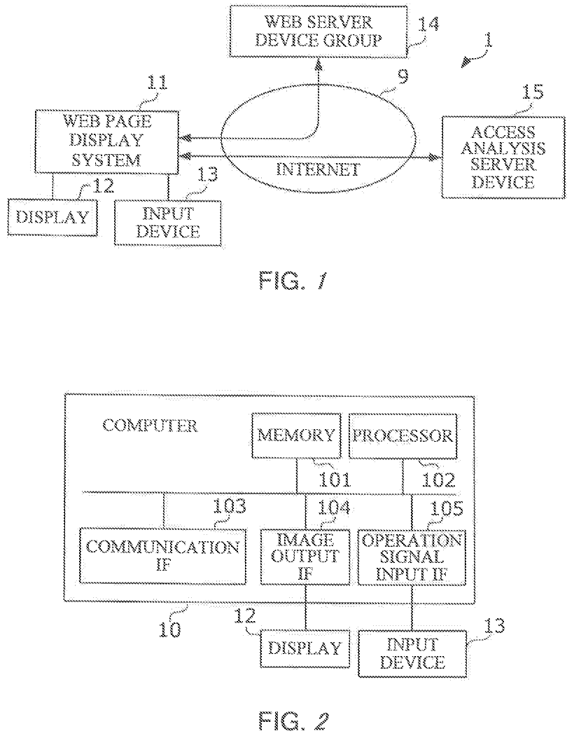

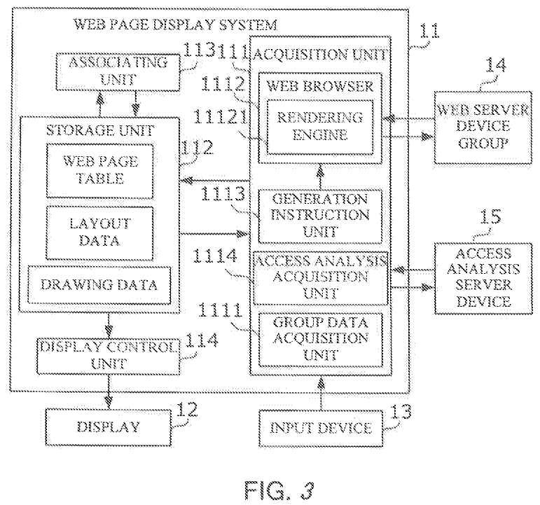

Web page display system 11 is implemented in a general-purpose computer executing data processing according to a program. FIG. 2 illustrates a configuration of computer 10 used to implement web page display system 11 together with display 12 and input device 13 connected to computer 10.

Display 12 is, for example, a liquid crystal display, and displays an image represented by data output from computer 10. Input device 13 is, for example, a keyboard and a mouse, accepts a user's operation and outputs an operation signal indicating content of the operation to computer 10. It is to be noted that a part or a whole of display 12 and input device 13 may be configured as a single device integrated with computer 10.

Computer 10 includes memory 101 that stores various data, processor 102 that performs various data processing according to a program stored in memory 101, communication IF 103 which is an interface for sending and receiving various data to and from an external device under control of processor 102, image output IF 104 that outputs data representing an image to display 12, and operation signal input IF 105 that is an interface that receives an input of an operation signal from input device 13.

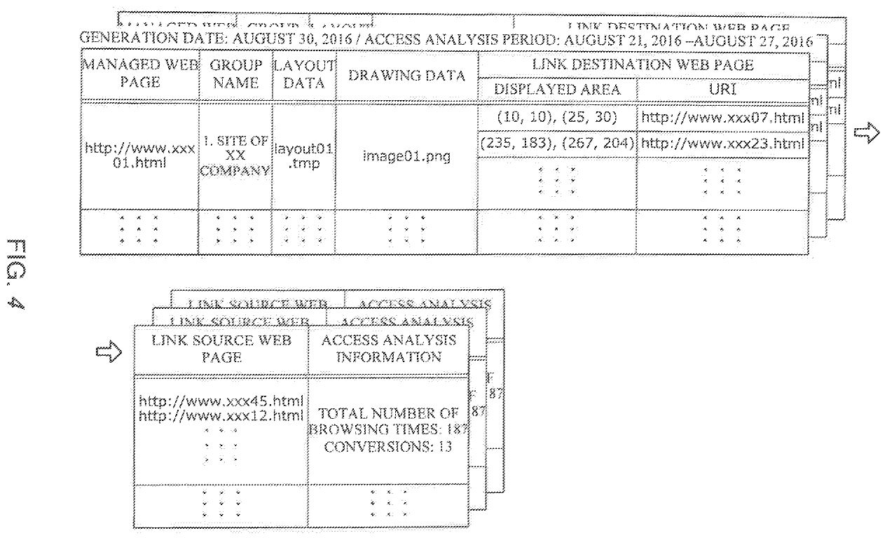

FIG. 3 illustrates a functional configuration of web page display system 11. That is, as processor 102 performs data processing according to a program for web page display system 11, computer 10 operates as web page display system 11 having components shown in FIG. 3.

Web page display system 11 includes acquisition unit 111, storage unit 112, associating unit 113 and display control unit 114. Acquisition unit 111 acquires various data. Acquisition unit 111 includes group data acquisition unit 1111, Web browser 1112, drawing data generation instruction unit 1113 and access analysis acquisition unit 1114.

Group data acquisition unit 1111 acquires group data input by a user using input device 13. Group data is data indicating URIs of plural web pages categorized into a plurality of groups. Group data acquired by group data acquisition unit 1111 is stored in storage unit 112 as a part of a web page table.

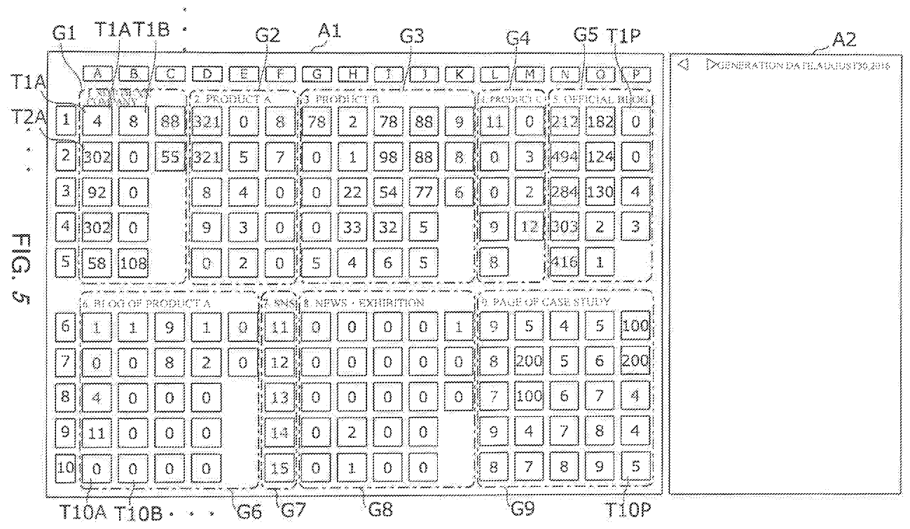

FIG. 4 illustrates an exemplary configuration of a web page table used to store the group data and drawing data indicating a displayed image and the like. The drawing data will be described later. Storage unit 112 stores plural web page tables, each of which corresponds to a different time stamp (for example, a one-week period).

For example, a frontmost web page table shown in FIG. 4 is a web page table generated on Aug. 30, 2016. This web page table stores data relating to drawing data generated on Aug. 30, 2016, and access analysis data showing access analysis information during the week from Aug. 21 to 27, 2016 which is an example of the predetermined period before Aug. 30, 2016.

A web page table is a group of data records related to each of web pages (hereinafter referred to as “managed web pages”) managed by a user. The web page table has data fields [managed web page], [group name], [layout data], [drawing data], [link destination web page], [link source web page], and [access analysis information].

In the data field [managed web page], a URI of a managed web page is stored. In the data field [group name], a group name of a group to which the managed web page belongs is stored. In the data field [layout data], a file name of layout data generated as intermediate data when Web browser 1112 displays the managed web page is stored. The layout data is data indicating displayed area of each of a plurality of elements included in a web page. In the data field [drawing data], a file name of drawing data is stored. The drawing data represents a displayed image of the managed web page generated by Web browser 1112.

In the data field [link destination web page], data relating to each one of web pages to which the managed web page has a link is stored. The data field [link destination web page] includes sub data fields [displayed area] and [URI]. In the sub data field [displayed area], data indicating a displayed area of an element attached by a link destination (hereinafter referred to as “link element”) among a plurality of elements included in the managed web page is stored. The data stored in the sub data field [displayed area] indicates a displayed area of the link element, for example, by a coordinate value of an upper left point of the displayed area and a coordinate value of the lower right point. In the sub data field [URI], a URI of the link destination web page attached to the link element is stored.

In the data field [link source web page], URIs of one or more web pages that has a link to the managed web page are stored. In the data field [access analysis information], access analysis data generated by access analysis server device 15 regarding the managed web page is stored.

The group data input by a user and acquired by group data acquisition unit 1111 is data stored in the data field [managed web page] and [group name] of the web page table.

The description of the configuration of web page display system 11 continues with reference to FIG. 3. Web browser 1112 is a known Web browser that receives various data from Web server device group 14 identified by a URI and generates drawing data indicating a displayed image of a web page by using various data received from Web server device group 14. Web browser 1112 includes rendering engine 11121 that generates web pages according to data described in a web page description language included in data received from Web server device group 14.

Rendering engine 11121 generates layout data indicating a displayed area of each of plural elements included in a web page as intermediate data according to data described in a web page description language. The layout data generated by rendering engine 11121 shows attributes of the plural elements included in the web page in addition to the displayed areas of the elements. An attribute of an element indicated by the layout data may include a URI of a link destination web page.

Rendering engine 11121 renders a displayed image of a web page according to the layout data generated as intermediate data and generates drawing data indicating the displayed image.

Generation instruction unit 1113 generates a new web page table periodically each time a predetermined time period (for example, every week) has elapsed. In the data fields [group name] and [managed web page] of the new web page table generated by the generation instruction unit 1113, data stored in the data fields [group name] and [managed web page] of the most recent past web page table is copied. It is to be noted that, when the user inputs new group data, generation instruction unit 11 updates the data stored in the data field [group name] and [managed web page] of the web page table according to the new group data.

After generating the new web page table as described above, generation instruction unit 1113 instructs Web browser 1112 to display each of plural web pages identified by a URI stored in the data field [managed web page] of the latest web page table. In accordance with this instruction, Web browser 1112 displays these web pages.

It is to be noted that, in general, when a Web browser displays a web page, the Web browser generates drawing data representing only a part of the whole web page. The part is an area that fits on a screen. In web page display system 11, Web browser 1112 generates drawing data of an entire web page in accordance with the instruction of generation instruction unit 1113.

The drawing data generated by Web browser 1112 in accordance with the instruction of generation instruction unit 1113 and the layout data generated as the intermediate data in the generation of the drawing data is stored in storage unit 112. File names of the layout data and the drawing data are respectively stored in the data fields [layout data] and [drawing data] of the corresponding data record of the latest web page table.

As described above, Web browser 1112 that generates the layout data and the drawing data according to the instruction of generation instruction unit 1113 functions as a functional element that acquires layout data and drawing data.

Access analysis acquisition unit 1114 receives access analysis data on each of plural web pages identified by URIs stored in the data field [managed web page] of the latest web page table from access analysis server device 15 periodically (for example, every week).

In access analysis server device 15, a Web site to be analysed is registered in advance. Access analysis server device 15 performs continuously access analysis concerning each registered Web site and each of plural web pages included in the Web site. In response to a request from web page display system 11, access analysis server device 15 transmits to web page display system 11 the access analysis data indicating a result of the access analysis during a past predetermined period (for example, one week whose last day is the latest day on which the access analysis is completed).

The access analysis data acquired by access analysis acquisition unit 1114 from access analysis server device 15 is stored in storage unit 112. Access analysis acquisition unit 1114 extracts or generates data indicating access analysis information relating to a web page corresponding to a URI stored in the data field [URI] of the web page table or relating to “other” web pages, from or based on access analysis data acquired from access analysis server device 15, and stores the data in the data field [access analysis information].

Web page display system 11 performs data communication with Web server device group 14 while Web browser 1112 is generating drawing data of a web page. In addition, web page display system 11 performs data communication with access analysis server device 15 while access analysis acquisition unit 1114 is acquiring access analysis data. During other periods, web page display system 11 does not need to perform data communication with an external device. Therefore, associating unit 113 and display control unit 114 executes the process described below offline.

When the new layout data is stored in the data field [layout data] of the latest web page table, associating unit 113 extracts, from among plural displayed areas indicated by the stored layout data, one or more displayed areas to which a URI of a link destination is attached as an attribute. Subsequently, with respect to each of the extracted one or more displayed areas, associating unit 113 stores data indicating the displayed areas included in the layout data and the URI of the link destination attached to the displayed area in the sub data fields [displayed area] and [URI] of the data field [linked web page], respectively. As a result, the link data is associated with the displayed data. Hereinafter, data indicating the displayed area and the URI of the link destination attached to the displayed area stored in the data field [linked web page] is referred to as “link data.”

With respect to all the data records of the latest web page table, when associating unit 113 completes storage of the link data for the data field [linked web page], associating unit 113 stores data in the data field [link source web page] of the latest web page table.

Specifically, associating unit 113 sequentially selects a target data record from data records of the latest web page table, and extracts a data record that includes a URI stored in the data field [target web page] of the target data record in the sub data field [URI] of the data field [linked web page] from the latest web page table. Subsequently, associating unit 113 stores a URI stored in the data field [managed web page] of the extracted data record in the data field [link source web page] of the target data record.

Display control unit 114 generates screen data representing an image to be displayed on a screen of display 12 by using the data stored in the web page table, and controls display 12 to display the image represented by the generated screen data (hereinafter referred to as “web page browsing screen”). The default web page table used by display control unit 114 for generating screen data is the latest web page table. After display 12 displays an image represented by the screen data generated using the latest web page table, in a case when a user operates to instruct to change the web page table to be used (described later), display control unit 114 generates screen data using an old web page table corresponding to the user's change instruction and controls display 12 to display a web page browsing screen represented by the generated screen data.

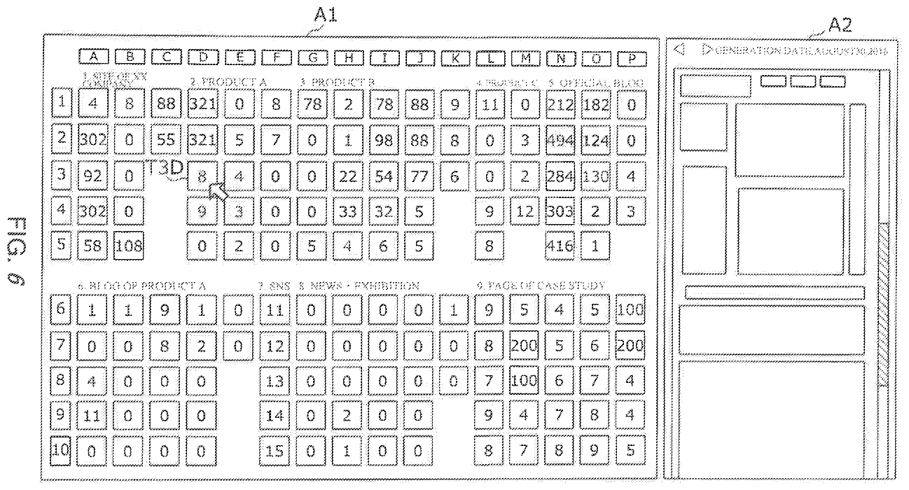

FIG. 5 schematically illustrates an exemplary web page browsing screen. The web page browsing screen includes displayed area A1 and displayed area A2. In displayed area A1, plural images of operation element T1A to T10P are displayed. The plurality of images of operation element T1A to T10P are arranged in a matrix having plural rows exemplified by a first to tenth row, and plural columns exemplified by columns A to P in FIG. 5. Hereinafter, a group of the plurality of images of operation elements arranged in the matrix form is referred to as a “menu image.” It is to be noted that the number included in the reference numeral “T1A” of the image of operation element T1A indicates the line number, and the letter at the end of the reference numeral indicates the column symbol. The same applies to other images of operation elements.

The menu image is divided into displayed areas G1 to G9 to which group names such as “1.xx corporate site” and “2. product A” are attached. In each of displayed areas G1 to G9, images of operation elements in which URIs of web pages belonging to the groups of the displayed areas are associated are arranged. That is, in each of displayed areas G1 to G9, images of operation elements associated with URIs are arranged. Each of the URIs is stored in the data field [managed web page] of the data record in which the group name of the displayed area is stored in the data field [group name] of the web page table.

In the menu image, there are three display modes of “non-selection mode,” “link source display mode,” and “link destination display mode.” A menu image of “non-selection mode” is a menu image displayed when none of images of operation elements is selected by a user. In the menu image of “non-selection mode,” a total number of times of browsing of a corresponding web page during a past predetermined period is displayed in each image of the operation element. The total number of times of browsing displayed in the image of the operation element is information indicated by data (data indicating number of times of viewing) included in the access analysis data stored in the data field [access analysis information] of the web page table used for generating the web page browsing screen. The menu image shown in FIG. 5 is a menu image of “non-selection mode.”

By viewing the menu image in the “non-selected mode,” a user can easily know a total number of times of viewing in each of the grouped web pages during a past predetermined period.

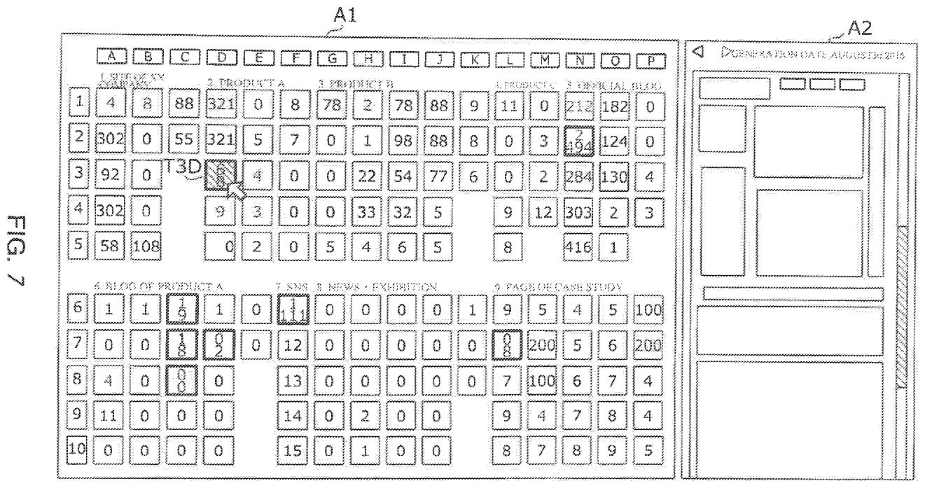

In the menu image of “non-selection mode,” when a user performs an operation of placing a mouse pointer on any of the images of the operation elements, that is, when the user performs mouseover, a web page corresponding to the mouseover image of the operation element is displayed in displayed area A2. FIG. 6 schematically illustrates a web page browsing screen displayed when a user performs mouseover on image of operation element T3D. In FIG. 6, the web page displayed in displayed area A2 is a web page corresponding to image of operation element T3D.

Upon detecting mouseover of any one of the images of the operation elements, display control unit 114 searches a web page table for a data record storing a URI associated with the mouseover image of the operation element in the data field [managed web page]. Subsequently, display control unit 114 reads the drawing data identified by a file name stored in the data field [drawing data] of the searched data record from storage unit 112. Display control unit 114 controls display 12 to display a web page indicated by the read drawing data in displayed area A2. As a result, the web page browsing screen shown in FIG. 6 is displayed by display 12.

As described above, the display of the web page corresponding to the mouseover image of the operation element is performed using drawing data generated and stored before a user performs mouseover. Accordingly, as compared with a case when rendering engine 11121 generates the web page after a user performs mouseover, the web page is displayed at a significantly high speed. Therefore, a user can promptly check contents of many web pages by performing mouseover on images of operation elements corresponding to web pages of interest.

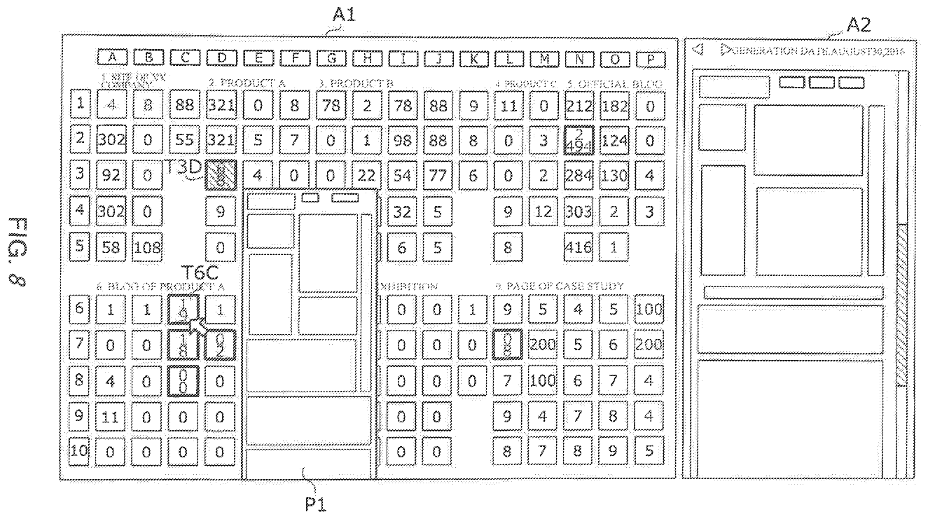

When a user clicks one of the images of the operation elements in a state where the menu image of “non-selection mode” is displayed, a menu image of “link source display mode” is displayed in displayed area A1. FIG. 7 schematically illustrates a web page browsing screen displayed when a click is made on image of operation element T3D in the menu image of “non-selected mode”.

In the menu image of the “link source display mode”, the image of the operation element selected by clicking by a user (hereinafter referred to as “selected image of an operation element) and images of operation elements corresponding to web pages of a link source of a web page corresponding to the selected image of operation element (hereinafter referred to as “link source image of operation element”) are displayed with an appearance different from the other images of operation elements. In the example of FIG. 7, image of operation element T3D, which is the selected image of the operation element, is bordered by a thick frame and is shown with a hatched background, so that it is distinguished from other images of operation elements. In the example of FIG. 7, images of operation element T7A, T1N or the like, which are link source images of operation elements, are bordered by thick frames, so that they are distinguished from other images of operation elements.

Further, in the menu image of the “link source display mode”, a color of the thick frame surrounding the selected image of the operation element is, for example, red, and a color of the thick frames surrounding the link source images of the operation elements is, for example, blue. In the menu image, thick frames surround images of operation elements corresponding to web pages of link sources and link destinations. In addition, the images of operation elements bordered by the thick blue frames correspond to the link source web pages, and images of operation elements bordered by the thick red frames correspond to the link destination web page. Accordingly, a user can intuitively understand the display mode of a current menu image and a relationship regarding links between plural linked web pages by the color of the thick frame.

In the menu image of the “link source display mode,” two numbers are displayed in the upper and lower two levels in each selected image of the operation element and the link source images of the operation elements. The number displayed in the lower row of the image of the operation element indicates a total number of times of viewing during a past predetermined period as in the case of “non-selection mode.” The number in the upper row of the selected image of the operation element indicates a number of times of viewing by visitors who have moved from web pages corresponding to link source images of operation elements from among a number of times of viewing during the past predetermined period. The number in the upper row of the link source image of the operation element indicates a number of times of viewing by visitors who have moved to web pages corresponding to the selected image of the operation element among a number of times of viewing during the past predetermined period. The numbers of times of viewing displayed in the upper row of the selected image of the operation element and the link source images of operation elements are information indicated by data (number of times of viewing data) included in the access analysis data stored in the data field [access analysis information] of the web page table.

By viewing the menu image in the “link source display mode,” a user can easily ascertain from which web pages visitors moved to the web page corresponding to the selected image of the operation element, and can ascertain how many visitors moved to the web page corresponding to the selected image of the operation element from each of the web pages.

When the menu image of the “link source display mode” is displayed in displayed area A1, a web page corresponding to the image of the operation element selected in the menu image is displayed in displayed area A2. In FIG. 7, the web page displayed in displayed area A2 is a web page corresponding to image of operation element T3D selected by a user.

When one of the images of operation elements is clicked to control display 12 to display the menu image of the “link source display mode” in displayed area A1, display control unit 114 searches a web page table for a data record storing a URI linked to the selected image of the operation element in the data field [managed web page]. Subsequently, display control unit 114 reads drawing data identified by a file name stored in the data field [drawing data] of the searched data record from the storage unit 112, and controls display 12 to display a web page indicated by the read drawing data in the displayed area A2. As a result, the web page browsing screen shown in FIG. 7 is displayed.

As described above, the display of the web page corresponding to the clicked image of the operation element is performed using drawing data generated and stored before clicking. Accordingly, as compared with a case when rendering engine 11121 generates the web page after clicking, the web page is displayed at a significantly high speed. Therefore, a user can promptly check contents of many web pages by clicking on images of operation elements corresponding to web pages of interest.

In the menu image of the “link source display mode,” when a user performs mouseover on any one of the link source images of the operation elements, a web page corresponding to the mouseover image of the operation element pops us near the mouseover image of the operation element. FIG. 8 schematically illustrates a web page browsing screen displayed when mouseover is performed on an image of operation element T6C, which is one of link source images of operation elements. In FIG. 8, the web page displayed in pop-up area P1 is a web page corresponding to an image of operation element T6C.

As shown in FIG. 8, since a user can simultaneously view the web page displayed in displayed area A2 and the web page displayed as a pop-up, the user can easily confirm the relevance and the like of the web pages.

In addition, the display of the web page in the pop-up area is performed using drawing data generated and stored before the mouseover is performed, similarly to the display of the web page in displayed area A2. Accordingly, as compared with a case when rendering engine 11121 generates the web page after mouseover is performed, the web page is displayed at a significantly high speed. Therefore, a user can promptly check contents of many web pages by performing mouseover on images of operation elements corresponding to the web pages of interest.

A URI of a link destination web page is associated with each of link elements included in the web page displayed in displayed area A2 by link data stored in the data field [linked web page] of a web page table. When a user performs mouseover operation on any of link elements in the web page displayed in displayed area A2, a web page identified by a URI associated with the mouseover link element, that is, a web page linked to the link element, pops up.

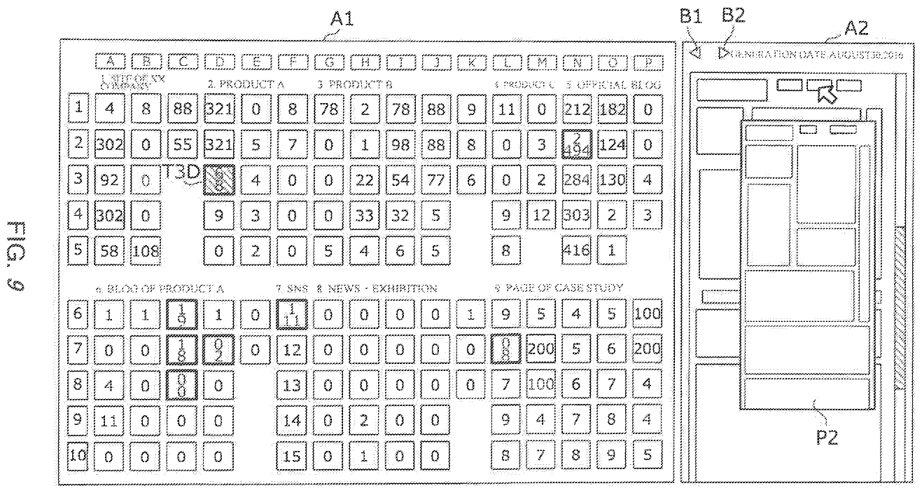

FIG. 9 schematically illustrates a web page browsing screen displayed when a user performs mouseover on link element A21 included in a web page displayed in displayed area A2. In FIG. 9, the web page displayed in pop-up area P2 is a web page linked to link element A21.

Upon detecting that mouseover is performed on displayed area of any of link elements included in the web page displayed in displayed area A2, display control unit 114 specifies a URI of a link destination web page corresponding to the displayed area where the mouseover has been performed in accordance with link data stored in data records of a web page table relating to the web page displayed in displayed area A2. Subsequently, display control unit 114 searches a web page table for a data record in which the specified URI of the link destination web page is stored in the data field [managed web page]. Subsequently, display control unit 114 reads drawing data identified by a file name stored in the data field [drawing data] of the searched data record from storage unit 112, and controls display 12 to display a web page indicated by the read drawing data in the pop-up area. As a result, the web page browsing screen shown in FIG. 9 is displayed.

As described above, the display of the web page linked to the mouseover link element is performed using drawing data generated and stored before a user performs mouseover. Accordingly, as compared with a case when rendering engine 11121 generates the web page after a user performs mouseover, the web page is displayed at a significantly high speed. Therefore, a user can promptly check contents of a web page linked to each of many link elements by performing mouseover on the link element of interest.

In the menu image of the “link source display mode,” a user can select a new image of an operation element by clicking on one of images of operation elements other than an image of an operation element selected at that time. For example, in the menu image shown in FIG. 7, when a user clicks on an image of operation element T4H, the image of operation element T4H becomes a new selected image of an operation element. That is, a web page corresponding to image of operation element T4H is displayed in displayed area A2. Instead of an image of operation element T3D, the image of operation element T4H is bordered by a thick red frame and displayed with hatching added to the background. In addition, instead of the image of the operation element of a link source of the image of operation element T3D, an image of an operation element of a link source of the image of operation element T4H is displayed bordered by a thick blue frame.

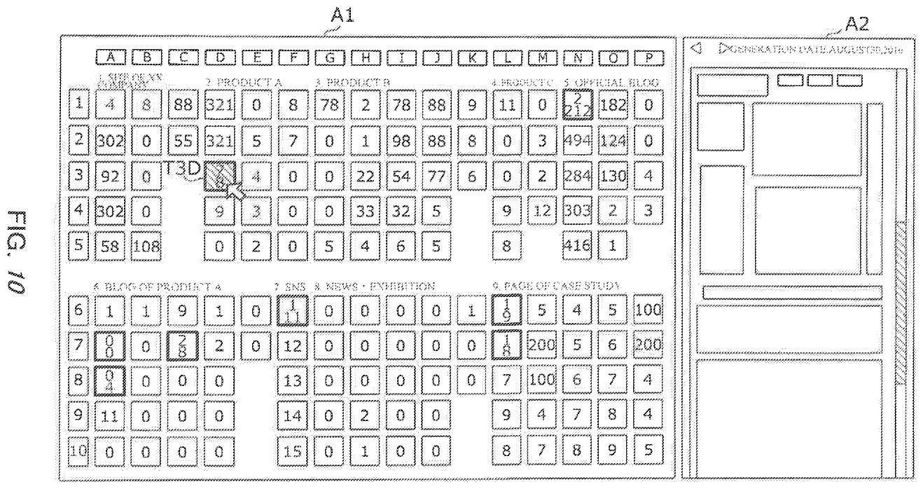

In the menu image of the “link source display mode,” a user can display the menu image of the “link destination display mode” in displayed area A1 by clicking an image of an operation element selected at that time. FIG. 10 schematically illustrates a web page browsing screen displayed when a user clicks on an image of operation element T3D selected in the menu image of “link source display mode.”

In the menu image of the “link destination display mode,” the selected image of the operation element and images of operation elements corresponding to web pages of link destinations of a web page corresponding to the selected image of the operation element (hereinafter referred to as “link destination image of operation element”) are displayed in a manner different from that of other images of operation elements. In the example shown in FIG. 10, an image of operation element T3D, which is the selected image of the operation element, is bordered by a thick blue frame and is shown with a hatched background, so that it is distinguished from other images of operation elements. In the example shown in FIG. 10, images of operation element T7A, T1N or the like, which are link destination images of operation elements, are bordered by thick red frames, so that they are distinguished from other images of operation elements.

Similarly to the case of the menu image of the “link source display mode,” the color of the thick frame of the menu image of the “link destination display mode” enables a user to understand intuitively the display mode of the current menu image and a relation regarding the links of plural linked web pages.

In the menu image of the “link destination display mode,” two numbers are displayed in the upper and lower two levels in each of the selected image of the operation element and the link destination images of the operation elements. Numbers displayed in the lower row of the images of the operation elements indicate a total number of times of viewing during a past predetermined period as in the case of “non-selection mode” and “link source display mode”. A number displayed in the upper row of the selected image of the operation element indicates a number of times of viewing by visitors who have moved to web pages corresponding to link destination images of operation elements from among the total number of times of viewing during the past predetermined period. A number in the upper row of the link destination image of the operation element indicates a number of times of viewing by visitors who have moved from web pages corresponding to the selected image of the operation element from among the total number of times of viewing during the past predetermined period. The numbers of times of viewing displayed in the upper row of the selected image of the operation element and the link destination images of the operation elements are information indicated by data (data of a number of times of viewing) included in the access analysis data stored in the data field [access analysis information] of the web page table, similarly to the total number of times of viewing displayed in the lower row.

By viewing the menu image in the “link destination display mode,” a user can easily ascertain to which web pages visitors moved from the web page corresponding to the selected image of the operation element, and can easily ascertain how many visitors moved from the web page corresponding to the selected image of the operation element to each of the web pages.

Also in the menu image of the “link destination display mode,” as in the case of the menu image of the “link source display mode,” when a user performs a mouseover on any one of the link destination images of the operation elements, a web page corresponding to the mouseover image of the operation element pops up. In addition, when a user performs mouseover on any of the link elements included in the web page displayed in displayed area A2 while the menu image of the “link destination display mode” is being displayed, a web page linked to the mouseover link element pops up.

Accordingly, also on the web page browsing screen including the menu image of the “link destination display mode,” a user can promptly gain an overview of contents of plural web pages linked to each other.

In the menu image of the “link destination display mode,” a user can select a new image of an operation element by clicking on any one of images of operation elements other than an image of an operation element selected at the time.

Furthermore, in the menu image of the “link destination display mode,” a user can display the menu image of “non-selected mode” in displayed area A1 by clicking an image of an operation element selected at that time.

Furthermore, a user can change a web page table used for generating screen data representing a web page browsing screen by clicking button B1 or B2 arranged in displayed area A2. As described above, storage unit 112 stores plural web page tables generated periodically (for example, every week). When a user clicks button B1, display control unit 114 generates screen data using a web page table of a generation date one generation older than a generation date of a web page table used at the time. Furthermore, when a user clicks button B2, display control unit 114 generates screen data by using a web page table of a generation date one generation newer than a generation date of a web page table used at that time.

Accordingly, when a user clicks button B1 or B2, content of a web page displayed in displayed area A2 changes to content of the older version or content of the newer version. The version of the web page displayed as a pop-up by mouseover on the link element or the image of the operation element also changes according to the click of button B1 or B2 by the user. Therefore, the user can easily gain an overview of contents of a web page that change with the passage of time.

According to web page display system 11 described above, a user such as an administrator of the Web site can promptly gain an overview of contents of the Web site.

### 2. Embodiment

Web page display system 21 according to the second embodiment of the present invention will be described below. Web page display system 21 has many features in common with web page display system 11 according to the first embodiment. Therefore, only features in which web page display system 21 differs from web page display system 11 will be described, and features common to web page display system 21 and web page display system 11 will be omitted. Further, the same reference numerals as those used in the description of the first embodiment are used for components that are common to web page display system 11 and web page display system 21.

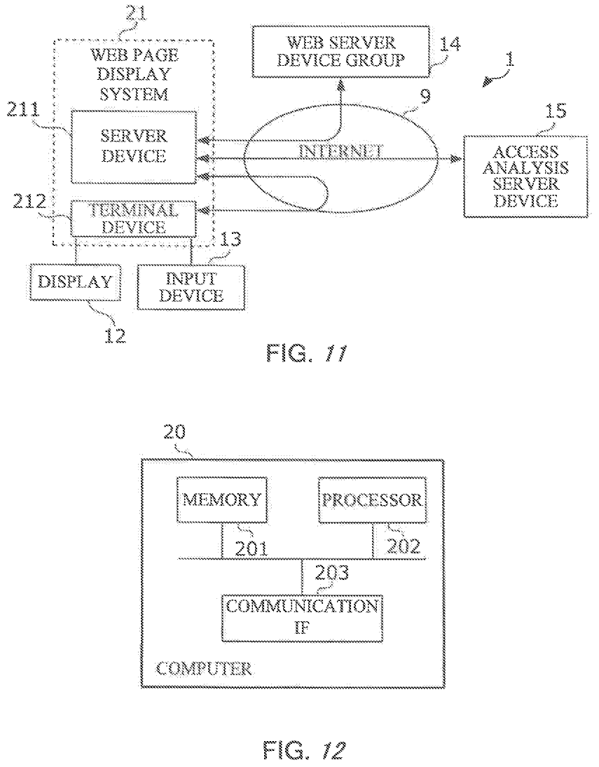

FIG. 11 illustrates the configuration of system 2 including web page display system 21. System 2 includes web page display system 21 in place of web page display system 11 included in system 1 according to the first embodiment.

Web page display system 21 includes server device 211 and one or more terminal devices 212. Server device 211 and terminal device 212 mutually perform data communication via Internet 9. It is to be noted that FIG. 11 and FIG. 13 described below illustrate a case where web page display system 21 includes only one terminal device 212.

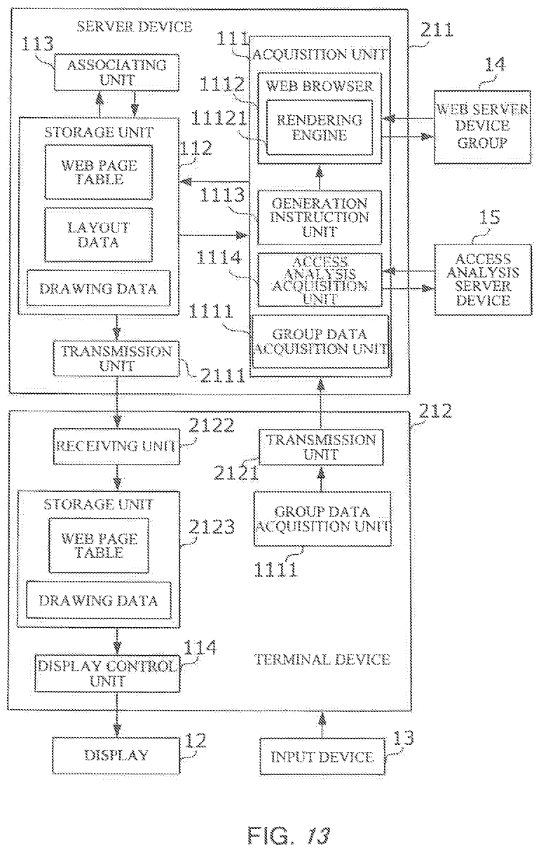

Server device 211 is implemented in a general purpose computer executing data processing according to a program. FIG. 12 illustrates a configuration of computer 20 used to implement server device 211.

Computer 20 includes memory 201 that stores various data, processor 202 that performs a variety of data processing according to a program stored in memory 201, and communication IF 203 that is an interface for sending and receiving a variety of data to and from an external device under control of processor 202.

Terminal device 212 is implemented in computer 10 shown in FIG. 2 performing data processing according to a program. As shown in FIG. 2, display 12 and input device 13 are connected to computer 10 used for implementing terminal device 212.

FIG. 13 illustrates a functional configuration of web page display system 21. That is, processor 202 performs data processing in accordance with a program for server device 211, whereby computer 20 operates as server device 211 having the functional elements shown in FIG. 13. Further, processor 102 performs data processing according to a program for terminal device 212, whereby computer 10 operates as terminal device 212 having the functional elements shown in FIG. 13.

Server device 211 includes acquisition unit 111, storage unit 112, associating unit 113, and transmission unit 2111. Acquisition unit 111, storage unit 112, and associating unit 113 included in server device 211 are the same as acquisition unit 111, storage unit 112 and associating unit 113 included in web page display system 11 according to the first embodiment. It is to be noted that group data acquisition unit 1111 of acquisition unit 111 included in server device 211 receives group data input by a user to input device 13 connected to terminal device 212 from terminal device 212, thereby to acquire the group data.

When a new web page table is generated and stored in storage unit 112 periodically (for example, every week) by processing of acquisition unit 111 and associating unit 113, transmission unit 2111 transmits the latest web page table and whole drawing data identified by a file name stored in the data field [drawing data] of the latest web page table to terminal device 212.

Terminal device 212 includes group data acquisition unit 1111, transmission unit 2121, receiving unit 2122, storage unit 2123 and display control unit 114. Group data acquisition unit 1111 and display control unit 114 included in terminal device 212 are the same as group data acquisition unit 1111 and display control unit 114 included in web page display system 11 according to the first embodiment.

Transmission unit 2121 transmits group data input by a user to input device 13 to server device 211. Receiving unit 2122 receives a web page table and drawing data from server device 211 periodically (for example, every week). Storage unit 2123 stores the web page table and the drawing data received by receiving unit 2122 from server device 211.

It is to be noted the web page table and the drawing data may not be transmitted periodically from server device 211 to terminal device 212. For example, when terminal device 212 displays a web page browsing screen according to a user's operation, terminal device 212 may request server device 211 to transmit a required web page table and drawing data, and server device 211 may transmit the web page table and the drawing data to terminal device 212 in response to a request from terminal device 212.

Also in web page display system 21, as in the case of web page display system 11, a user can promptly gain an overview of contents of a Web site on the web page browsing screen displayed on display 12.

### 3. Embodiment

Web page display system 31 according to the third embodiment of the present invention will be described below. Web page display system 31 has many features in common with web page display system 11 according to the first embodiment. Therefore, only features in which web page display system 31 differs from web page display system 11 will be described, and features common to web page display system 31 and web page display system 11 will be omitted. Further, the same reference numerals as those used in the description of the first embodiment are used for components that are common to web page display system 11 and web page display system 21.

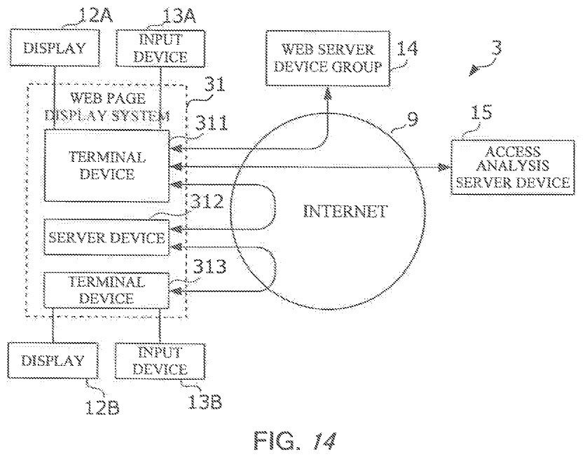

FIG. 14 illustrates a configuration of system 2 including web page display system 31. System 3 includes web page display system 31 in place of web page display system 11 included in system 1 according to the first embodiment. System 3 includes display 12A, input device 13A, display 12B and input device 13B in place of display 12 and input device 13 included in system 1. Display 12A and input device 13 A are connected to terminal device 311 included in web page display system 31. Display 12B and input device 13B are connected to terminal device 313 included in web page display system 31.

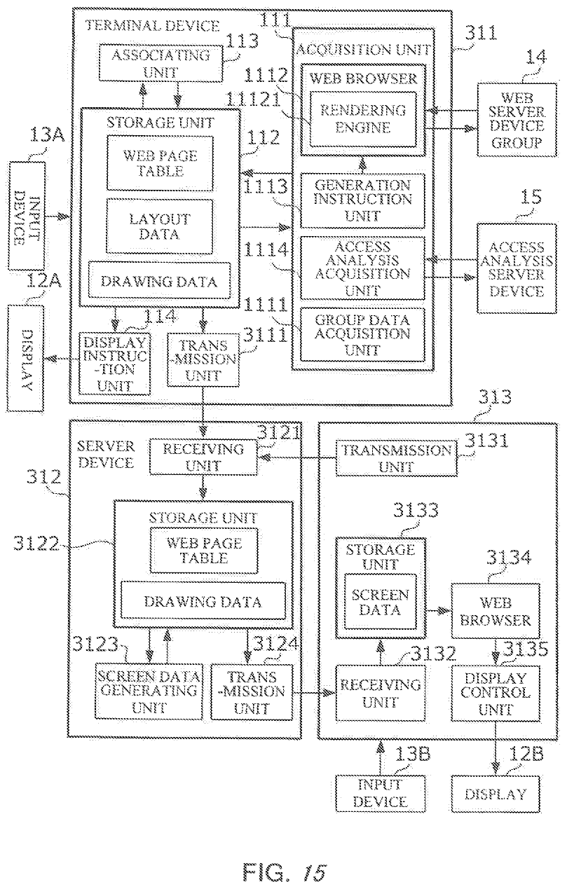

Web page display system 31 includes terminal device 311, server device 212, and one or more terminal devices 313 of system 3. Terminal device 311 is a terminal device operated by an administrator of system 3. Terminal device 313 is a terminal device operated by a user of system 3 (such as a manager of a Web site). FIG. 14 and FIG. 15 described later illustrate a case where web page display system 31 includes only one terminal device 313.

In system 3, drawing data and a web page table are generated by terminal device 311 according to an operation by an administrator of system 3. The drawing data and the web page table generated by terminal device 311 are uploaded to server device 312. In response to a request transmitted from terminal device 313 in accordance with an operation by a user of system 3 (such as an administrator of a Web site), server device 312 generates screen data representing a web page browsing screen, and transmits the generated screen data to requesting terminal device 313. Terminal device 313 controls display 12B to display the web page browsing screen represented by the screen data received from server device 312. As a result, display 12B displays the web page browsing screen.

Terminal device 311 and terminal device 313 are implemented in computer 10 shown in FIG. 2 performing data processing according to a program. It is to be noted that display 12A and input device 13A are connected to computer 10 used to implement terminal device 311 in place of display 12 and input device 13 shown in FIG. 2. In addition, display 12B and input device 13B are connected to computer 10 used to implement terminal device 313 in place of display 12 and input device 13 shown in FIG. 2.

Server device 312 is implemented in computer 20 shown in FIG. 12 performing data processing according to a program.

FIG. 15 illustrates a functional configuration of web page display system 31. That is, processor 102 performs data processing according to a program for terminal device 311, whereby computer 10 operates as terminal device 311 having the functional elements shown in FIG. 15. Further, processor 202 performs data processing according to a program for server device 312, whereby computer 20 operates as server device 312 having the functional elements shown in FIG. 15. Further, processor 102 performs data processing according to a program for terminal device 313, whereby computer 10 operates as terminal device 313 having the functional elements shown in FIG. 15.

Terminal device 311 includes acquisition unit 111, storage unit 112, associating unit 113, display control unit 114, and transmission unit 3111. Acquisition unit 111, storage unit 112, associating unit 113, and display control unit 114 included in terminal device 311 are the same as acquisition unit 111, storage unit 112, associating unit 113, and display control unit 114 included in web page display system 11 according to the first embodiment.

It is to be noted that group data acquisition unit 1111 of acquisition unit 111 included in terminal device 311 acquires group data input by an administrator of system 3 to input device 13A connected to terminal device 311.

When the administrator of system 3 instructs generation of drawing data by an operation using input device 13A, generation instruction unit 1113 of terminal device 311 delivers a URI to Web browser 1112 and instructs generation of layout data and drawing data according to the instruction. Further, when the administrator of system 3 instructs acquisition of access analysis data by an operation using input device 13A, access analysis acquisition unit 1114 of terminal device 311 acquires the access analysis data from access analysis server device 15 according to the instruction.

The administrator of system 3 gives an instruction to terminal device 311, for example, every time a predetermined time has elapsed, using input device 13A, and causes terminal device 311 to generate a web page table in which new layout data, new drawing data, and new access analysis data are stored. The administrator of system 3 instructs terminal device 311 to display a web page browsing screen using the new web page table using input device 13A, and confirms that the web page browsing screen is correctly displayed on display 12A. Thereafter, the administrator of system 3 instructs terminal device 311 to transmit the latest web page table and the latest drawing data to server device 312 by using input device 13A.

In accordance with the instruction from the administrator of system 3, transmission unit 3111 transmits the latest web page table and whole drawing data identified by a file name stored in the data field [drawing data] of the latest web page table to server device 312.

Server device 312 includes receiving unit 3121, storage unit 3122, screen data generating unit 3123, and transmission unit 3124. Receiving unit 3121 receives a web page table and data indicating a display image from terminal device 311. Further, receiving unit 3121 receives a request to transmit screen data from terminal device 313. Storage unit 3122 stores the web page table and the drawing data received by receiving unit 3121.

When receiving unit 3121 receives a request to transmit screen data from terminal device 313, screen data generating unit 3123 generates screen data representing a web page browsing screen using the web page table and the drawing data stored in storage unit 3122 in response to the request. The screen data generated by screen data generating unit 3123 is a group of data described in a web page description language such as HTML, image data referred to by these data, and so on.

Transmission unit 3124 transmits the screen data generated by screen data generating unit 3123 to requesting terminal device 313.

Terminal device 313 includes transmission unit 3131, receiving unit 3132, storage unit 3133, Web browser 3134, and display control unit 3135. In accordance with an instruction to display a web page browsing screen using input device 13B of a user (such as an administrator of the web page), transmission unit 3131 transmits to server device 312 a request for transmission of screen data corresponding to the instruction.

Receiving unit 3132 receives screen data transmitted from server device 312 in response to the request transmitted from transmission unit 3131. Storage unit 3133 stores the screen data received by receiving unit 3132. Web browser 3134 generates a web page browsing screen using the screen data stored in storage unit 3133. Display control unit 3135 controls display 12B to display the web page browsing screen generated by Web browser 3134.

Similarly to the case of web page display system 11, web page display system 31 enables a user to promptly gain an overview of contents of a Web site on a web page browsing screen displayed on display 12B.

The embodiments described above can be modified in various ways within the scope of technical ideas of the present invention. Examples of such modifications are indicated below. Two or more of the following modifications may be combined.

(1) A configuration of the web page display system according to the present invention is not limited to the configuration exemplified in web page display system 11, web page display system 21, and web page display system 31 described above. For example, instead of terminal device 311 and server device 312 provided in web page display system 31, a configuration including one device integrating terminal device 311 and server device 312 may be adopted.

(2) In the embodiments described above, URIs of web pages are stored in the sub data field [URI] of the data field [link destination web page] and the data field [link source web page] of a web page table. Instead of these URIs, data such as a file name for identifying drawing data may be used.

(3) In the embodiments described above, the drawing data used for generating a web page browsing screen may be drawing data indicating an image having a lower resolution than the resolution of the image indicated by the drawing data generated by rendering engine 11121. In this modification, web page display system 11, server device 211, or terminal device 311 includes a conversion unit that performs a conversion process to a lower resolution of drawing data generated by rendering engine 11121. In addition to or instead of the drawing data generated by rendering engine 11121, the low-resolution drawing data generated by the conversion unit is stored in the web page table. Display control unit 114 or screen data generating unit 3123 uses the low-resolution drawing data when generating screen data representing a web page browsing screen. In this modification, a smaller amount of drawing data is used, so that the display of a web page on a web page browsing screen is performed at a higher speed. It is to be noted that the low-resolution drawing data may be used for display of a web page to be displayed as a pop-up image, and drawing data of normal resolution may be used for display of a web page displayed in displayed area A2.

(4) In the embodiments described above, a displayed area of a link element on a web page is represented by a combination of the upper left coordinate value and the lower right coordinate value of the displayed area. A method of representing the displayed area is not limited to this. For example, a displayed area may be represented by the upper left coordinate value, a height and a width.

(5) In the embodiments described above, switching of the display mode of the menu image is performed by clicking the image of the operation element. A method of switching the display mode of the menu image is not limited to this. For example, a button for switching the display mode is arranged on the web page browsing screen, and the display mode of the menu image may be switched when a user clicks this button.

(6) In the embodiments described above, when a user performs a predetermined operation such as clicking on a link element included in a web page displayed in displayed area A2, a web page linked to a link element on which an operation is performed may be displayed in displayed area A2. Also in this case, display of a web page linked to the operated link element is performed promptly by using previously stored drawing data.

(7) In the embodiments described above, when a user performs mouseover on an image of an operation element or a link element, a web page is displayed in displayed area A2 (in the non-selection mode) or the pop-up area (in the link source display mode or the link destination display mode). When clicking on an image of an operation element or a link element is performed, a web page is displayed in displayed area A2. A predetermined operation performed by a user to display a web page in the pop-up area or displayed area A2 is not limited to mouseover or clicking. For example, an operation other than clicking such as double clicking may be adopted as a predetermined operation for displaying a web page in displayed area A2. Further, when a touch display in which display 12 and input device 13 are integrated is used, operations such as a tap instead of mouseover, and/or a double tap instead of a click, may be adopted as a predetermined operation for displaying a web page.

(8) In the embodiments described above, when a user performs mouseover on an image of an operation element in the non-selection mode, a web page is displayed in displayed area A2. When a user performs mouseover on an image of an operation element in the link source display mode or the link destination display mode, a web page is displayed in the pop-up area. Further, when a user performs mouseover on a link element of a web page displayed in displayed area A2 in the link source display mode or the link destination display mode, a web page is displayed in the pop-up area. Areas in which a web page is displayed in accordance with an operation such as mouseover or clicking are not limited to these areas. For example, when a user performs mouseover on an image of an operation element in the non-selection mode, a web page may be displayed in the pop-up area rather than in displayed area A2.

(9) In the embodiments described above, in the link source display mode, an image of an operation element displayed as a pop-up web page by mouseover is limited to a link source image of an operation element. Also, in the embodiments described above, in the link destination display mode, an image of an operation element displayed as a pop-up web page by mouseover is limited to a link destination image of an operation element. The image of the operation element displayed as a web page in accordance with a predetermined operation such as mouseover is not limited as described above. For example, in the link source display mode or the link destination display mode, even when a user performs mouseover or the like on an image of an operation element that is not an image of an operation element of a link source or a link destination, a web page may be displayed in a pop-up area.

(10) Web page display system 11 according to the first embodiment, server device 211 and terminal device 212 according to the second embodiment, and terminal device 311, server device 312 and terminal device 313 according to the third embodiment are implemented in computers executing processes according to programs. In place thereof, one or more of web page display system 11, server device 211, terminal device 212, terminal device 311, server device 312, and terminal device 313 may be configured as a so-called dedicated device.

(11) A program for causing a computer to execute processes to be performed by web page display system 11, a program for causing a computer to execute processes to be performed by server device 211, a program for causing a computer to execute processes performed by terminal device 212, a program for causing a computer to execute processes to be performed by terminal device 311, a program for causing a computer to execute processes performed by server device 312, and a program for causing a computer to execute processes to be performed by terminal device 313 may be distributed in a form of being continuously recorded on a computer-readable recording medium. In this case, the computer operates as web page display system 11, server device 211, terminal device 212, terminal device 311, server device 312 or terminal device 313 by reading the program from the recording medium and performing the processing according to the read program. These programs may be stored in a server device, transmitted from the server device to a computer via a network, and used in the computer.

### REFERENCE SIGNS LISTED

1 . . . system
2 . . . system
3 . . . system
9 . . . Internet
10 . . . computer
11 . . . web page display system
12 . . . display
13 . . . input device
14 . . . Web server device group
15 . . . access analysis server device
20 . . . computer
21 . . . web page display system
31 . . . web page display system
101 . . . memory
102 . . . processor
103 . . . communication IF
104 . . . image output IF
105 . . . operation signal input IF
111 . . . acquisition unit
112 . . . storage unit
113 . . . associating unit
114 . . . display control unit
201 . . . memory
202 . . . processor
203 . . . communication IF
211 . . . server device
212 . . . terminal device
311 . . . terminal device
312 . . . server device
313 . . . terminal device
1111 . . . group data acquisition unit
1112 . . . Web browser
1113 . . . generation instruction unit
1114 . . . access analysis acquisition unit
2111 . . . transmission unit
2121 . . . transmission unit
2122 . . . receiving unit
2123 . . . storage unit
3111 . . . transmission unit
3121 . . . receiving unit
3122 . . . storage unit
3123 . . . screen data generating unit
3124 . . . transmission unit
3131 . . . transmission unit
3132 . . . receiving unit
3133 . . . storage unit
3134 . . . Web browser
3135 . . . display control unit
11121 . . . rendering engine

What is claimed is:

1-7. (canceled)

8. A system comprising:
an acquisition unit that acquires drawing data and layout data with respect to each of a plurality of web pages, the drawing data indicating a displayed image of a web page and being generated by a rendering engine in accordance with data described in a web page description language, the layout data indicating a displayed area and an attribute of each of a plurality of elements included in the web page, the displayed area being decided by the rendering engine in generating the displayed image of the web page;
an associating unit that extracts one or more displayed areas from a plurality of displayed areas indicated by the layout data of each of the plurality of web pages, the extracted one or more displayed areas having a link as the attribute, and associates link data to the drawing data of the web page with respect to each of the extracted one or more displayed areas, the link data indicating the displayed area and a destination added to the displayed area; and
a display control unit that controls a display to display an image of a web page, which is selected by a user from among the plurality of the web pages,
wherein
if a predetermined operation is performed by the user on any one of the one or more displayed areas to which the link data is associated, while a first web page is displayed on the display under the control of the display control unit in accordance with first drawing data, the display control unit controls the display to display a second web page indicated by second drawing data acquired by the acquisition unit, so as to display an image of a web page of a link destination corresponding to the link data.

9. A system according to claim 8, wherein:
the acquisition unit acquires group data indicating to which group each of the plurality of web pages belongs;
the display control unit controls the display to display a menu image including a plurality of displayed areas for images of operation elements, each of the displayed areas corresponding to each of groups indicated by the group data, each of the images of operation elements corresponding to each of web pages belonging to the groups, the images of operation elements being arranged in a matrix in the corresponding displayed areas of the groups; and
if a predetermined operation is performed by the user on any one of the images of operation elements, while the menu image is displayed by the display according to control of the display control unit, the display control unit controls the display to display a web page indicated by third drawing data acquired by the acquisition unit, so as to display an image of a web page corresponding to the image of the operation element.

10. A system according to claim 9, wherein:
the acquisition unit acquires viewing number data indicating a number of times of viewing by visitors moving from a web page selected by a user to a linked web page during a past predetermined period, for each of one or more web pages accessed via a link from the web page selected during the predetermined period; and
the display control unit controls the display to display the images of operation elements in the menu image, each of the images of operation elements including a number of viewing times indicated by the viewing number data and corresponding to each of one or more web pages accessed via a link from the selected web page.

11. A system according to claim 9, wherein
the acquisition unit acquires viewing number data indicating a number of times of viewing by visitors moving from a link source web page to a web page selected by a user during a past predetermined period, for each of one or more web pages linked to the web page selected during the predetermined period; and
the display control unit controls the display to display the images of operation elements in the menu image, each of the images of operation elements including a number of viewing times indicated by the viewing number data and corresponding to each of one or more web pages linked to the selected web page.

12. A system according claim 8, comprising:
a server device that has the acquisition unit, the associating unit, and a transmission unit that transmits the drawing data and the link data related to each of the plurality of web pages; and
a terminal device that has a receiving unit and the display control unit, the receiving unit receiving the drawing data and the link data related to each of the plurality of web pages from the server device.

13. A computer program that causes a computer to execute processes comprising:
a process for acquiring drawing data and layout data with respect to each of a plurality of web pages, the drawing data indicating a displayed image of a web page and being generated by a rendering engine in accordance with data described in a web page description language, the layout data indicating a displayed area and an attribute of each of a plurality of elements included in the web page, the displayed area being decided by the rendering engine in generating the displayed image of the web page;
a process for extracting one or more displayed areas from a plurality of displayed areas indicated by the layout data of each of the plurality of web pages, the extracted one or more displayed areas having a link as the attribute, and associating link data to the drawing data of the web page with respect to each of the extracted one or more displayed areas, the link data indicating the displayed area and a destination added to the displayed area;
a process for controlling a display to display an image of a web page, which is selected by a user from among the plurality of the web pages; and
a process for, if a predetermined operation is performed by the user on any one of the one or more displayed areas to which the link data is associated while a first web page is displayed on the display under the control in accordance with first drawing data, controlling the display to display a second web page indicated by second drawing data, so as to display an image of a web page of a link destination corresponding to the link data.

14. A computer-readable recording medium storing a computer program that causes a computer to execute processes comprising:
a process for acquiring drawing data and layout data with respect to each of a plurality of web pages, the drawing data indicating a displayed image of a web page and being generated by a rendering engine in accordance with data described in a web page description language, the layout data indicating a displayed area and an attribute of each of a plurality of elements included in the web page, the displayed area being decided by the rendering engine in generating the displayed image of the web page;
a process for extracting one or more displayed areas from a plurality of displayed areas indicated by the layout data of each of the plurality of web pages, the extracted one or more displayed areas having a link as the attribute, and associating link data to the drawing data of the web page with respect to each of the extracted one or more displayed areas, the link data indicating the displayed area and a destination added to the displayed area;
a process for controlling a display to display an image of a web page, which is selected by a user from among the plurality of the web pages; and
a process for, if a predetermined operation is performed by the user on any one of the one or more displayed areas to which the link data is associated while a first web page is displayed on the display under the control in accordance with first drawing data, controlling the display to display a second web page indicated by second drawing data, so as to display an image of a web page of a link destination corresponding to the link data.
